(19) United States
(12) Patent Application Publication
(10) Pub. No.: US 2017/0083210 A1
(43) Pub. Date: Mar. 23, 2017

(54) COLLABORATION ROOM SWITCHING

(71) Applicant: Cisco Technology, Inc., San Jose, CA (US)

(72) Inventors: Marcellos PARKER, Alpine, CA (US); Jeremy SANTY, Kapaa, HI (US); Justin STYLER, Highland, UT (US); Lonny CHU, Walnut Creek, CA (US)

(21) Appl. No.: 14/859,308

(22) Filed: Sep. 20, 2015

(51) Int. Cl. G06F 3/0484; G06F 3/0482; G06F 3/0488; H04L 12/58

(52) U.S. Cl. CPC G06F 3/04842; H04L 51/04; G06F 3/0482; G06F 3/04883

(57) ABSTRACT

In one embodiment, a method for switching conversational context in a collaborative environment is implemented on a computing device and includes: presenting a group conversation on a display screen associated with the computing device, where the presenting comprises display of at least collaborative communications and associated participant avatars, detecting selection of one of the associated participant avatars in the group conversation, switching from the group conversation to an individual conversation, the individual conversation conducted between individual conversation participants, where the individual conversation participants include a user of the computing device and one of the conversation participants according to the selected participant avatar, and replacing the group conversation on the display screen with a presentation of the individual conversation.

### FIELD OF THE INVENTION

The present invention generally relates to the switching of conversational context in a collaborative environment.

### BACKGROUND OF THE INVENTION

In messaging and/or collaboration applications it is common to conduct “conversations” between individual users and/or groups of users. Such conversations typically comprise communications such as text, voice, images, hyperlinks, and/or media content that are exchanged between the participants of the conversation. Each such communication is typically associated with its contributing participant by user name and/or avatar.

### BRIEF DESCRIPTION OF THE DRAWINGS

The present invention will be understood and appreciated more fully from the following detailed description, taken in conjunction with the drawings in which:

FIGS. 1A-C are simplified pictorial illustrations of an exemplary user client device in a collaborative conversation, constructed and operative in accordance with embodiments described herein;

FIG. 2 is a schematic illustration of the exemplary user device of FIGS. 1A-C; and

FIG. 3 is a flowchart of a conversational context switching process performed by the exemplary user device of FIG. 2.

### DESCRIPTION OF EXAMPLE EMBODIMENTS

### Overview

A method for switching conversational context in a collaborative environment is implemented on a computing device and includes: presenting a group conversation on a display screen associated with the computing device, where the presenting comprises display of at least collaborative communications and associated participant avatars, detecting selection of one of the associated participant avatars in the group conversation, switching from the group conversation to an individual conversation, the individual conversation conducted between individual conversation participants, where the individual conversation participants include a user of the computing device and one of the conversation participants according to the selected participant avatar, and replacing the group conversation on the display screen with a presentation of the individual conversation.

### DETAILED DESCRIPTION OF EXAMPLE EMBODIMENTS

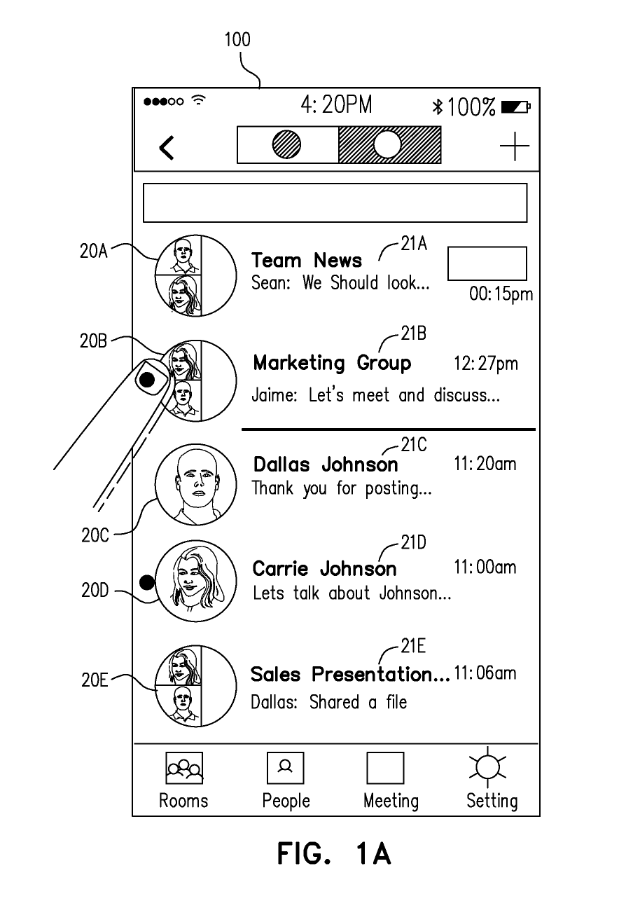

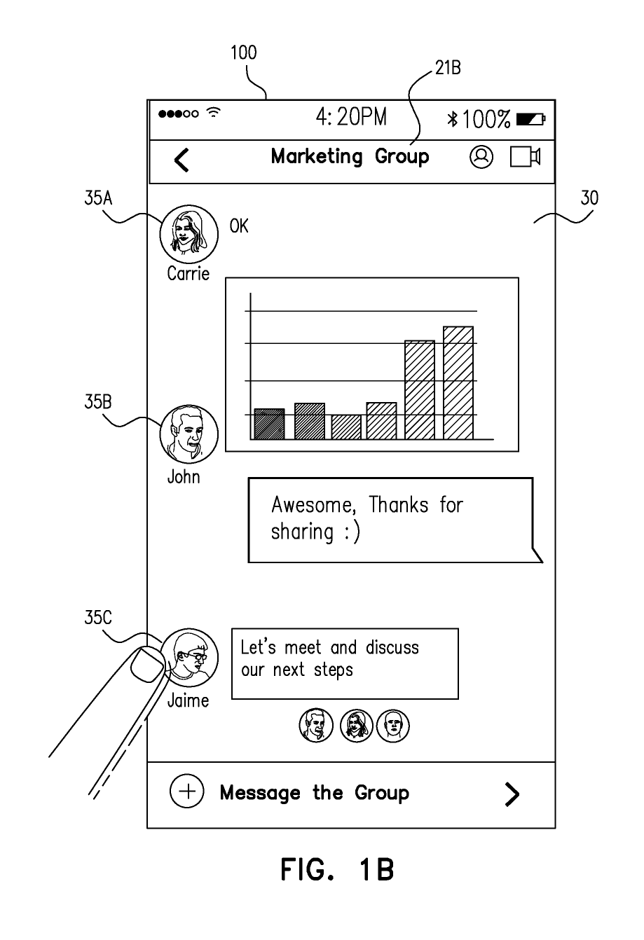

Reference is now made to FIG. 1A which is a simplified pictorial illustration of an exemplary user client device 100 operative to participate in a collaborative conversation, constructed and operative in accordance with embodiments described herein. As depicted in FIG. 1A, the display of device 100 may present an exemplary list of “conversation rooms” to be selected by a user. Each of the rooms is represented by a room avatar 20 and an associated room name 21.

For example, as shown, room avatar 20A is associated with room name 21A, i.e., “Team News”. It will be appreciated that a conversation room may be associated with either an individual, i.e., one-to-one, conversation or a group conversation. In an individual conversation, the conversation may be conducted between the user of device 100 and one other participant. For example, room avatars 20C and 20D comprise a thumbnail portrait of a single person, as per profile pictures associated with the individual users participating in the individual conversations. Accordingly, per the example, room name 21C is “Dallas Johnson” to indicate a conversation room for a conversation between the user of device 100 and Dallas Johnson. Room name 21D is “Carrie Johnson”, thereby indicating a conversation room for a conversation between the user of device 100 and Carrie Johnson. It will be appreciated that room names 21 may be assignable by the creator of a room; the examples herein may use the names of the participating individuals for ease of presentation.

As depicted in FIG. 1A, room avatars 20A, 20B and 20E each comprise multiple thumbnail portraits associated with multiple individual users participating in a group conversation. Accordingly, per the example, room name 21A is “Team News” to indicate a conversation room for a group conversation including the user of device 100 and other members of a team. Room name 21B is “Marketing Group”, thereby indicating a conversation room for a group conversation between the user of device 100 and other members of a marketing group. Room name 21E is “Sales Presentation”, thus indicating a group conversation regarding a sales presentation in which the user of device 100 is a participant. It will be appreciated that the participants in a group conversation room may not necessarily be restricted to members of a pre-existing group. The participants of a group conversation room may be invited by the creator of the conversation room on an ad hoc basis. Similarly, even if the conversation room was indeed created for use by members of a specific group, the creator may invite additional participants without specific regard to a group membership. It will also be appreciated that the conversation room creator may allow other participants to invite new participants.

In accordance with an exemplary embodiment described herein, device 100 may be configured with a touchscreen interface and the user of device 100 may select to enter the conversation room associated with room avatar 20B (i.e., the “Marketing Group” conversation room) by tapping on room avatar 20B. It will be appreciated by one of ordinary skill in the art that a mouse click or other suitable means may also be used to select room avatar 20B instead, or in addition to, touchscreen functionality.

Reference is now made to FIG. 1B which is a simplified pictorial illustration of user device 100 after the selection of room avatar 20B as per the exemplary embodiment of FIG. 1A. As depicted in FIG. 1B, client device 100 is now displaying conversation room 30 which is labeled with room name 21B, i.e. “Marketing group”. Participant avatars 35A-35C represent individual participants in group conversation room 30. As per the exemplary embodiment of FIG. 1B, participant avatar 35A represents the participation of “Carrie”; participant avatar 35B represents the participation of “John”; and participant avatar 35C represents the participation of “Jaime”. As depicted in FIG. 1B, the contribution of each participant to the conversation, e.g. a text post, image, hyperlink, etc. is shown to the right of the relevant participant avatar 35. For example, participant “John” may have posted “Awesome, Thanks for sharing:)” and participant “Jaime” may have posted “Let's meet and discuss our next steps.”

In accordance with embodiments described herein, the user of device 100 may select a participant from among those participating in a group conversation to move to a “private room”, i.e. a one-to-one conversation between the selected participant and the user of device 100. As depicted in FIG. 1B, the user may select “Jaime” by tapping on participant avatar 35C. Alternatively, or in addition, as described hereinabove, the user may perform the selection via mouse click or other suitable means.

Reference is now made to FIG. 1C which is a simplified pictorial illustration of client device 100 after the selection of participant avatar 35C as per the exemplary embodiment of FIG. 1B. It will be appreciated by one of ordinary skill in the art that as indicated by room name 26C the conversational context for private conversation room 40 may now be an individual, one-to-one conversation with “Jaime”, per the selection in the exemplary embodiment of FIG. 1B.

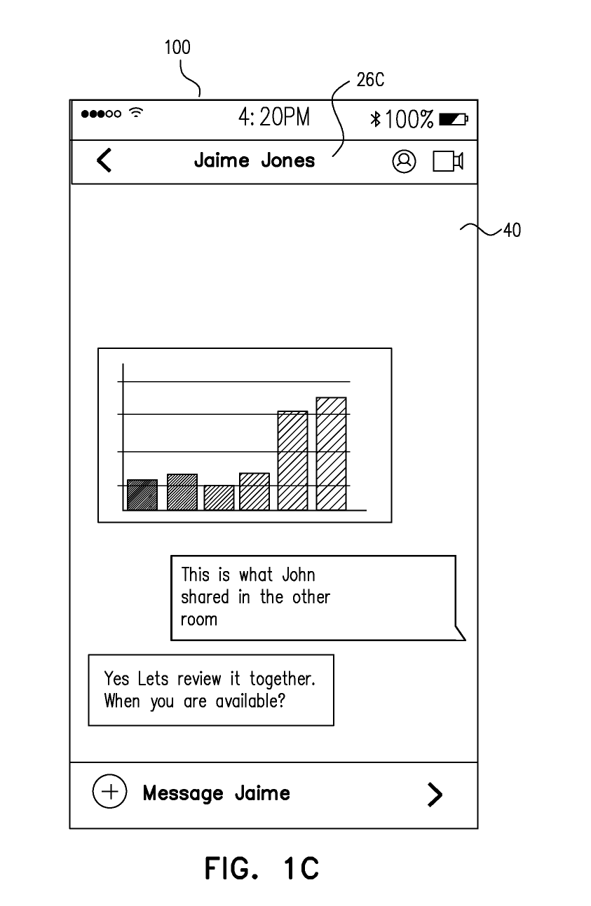

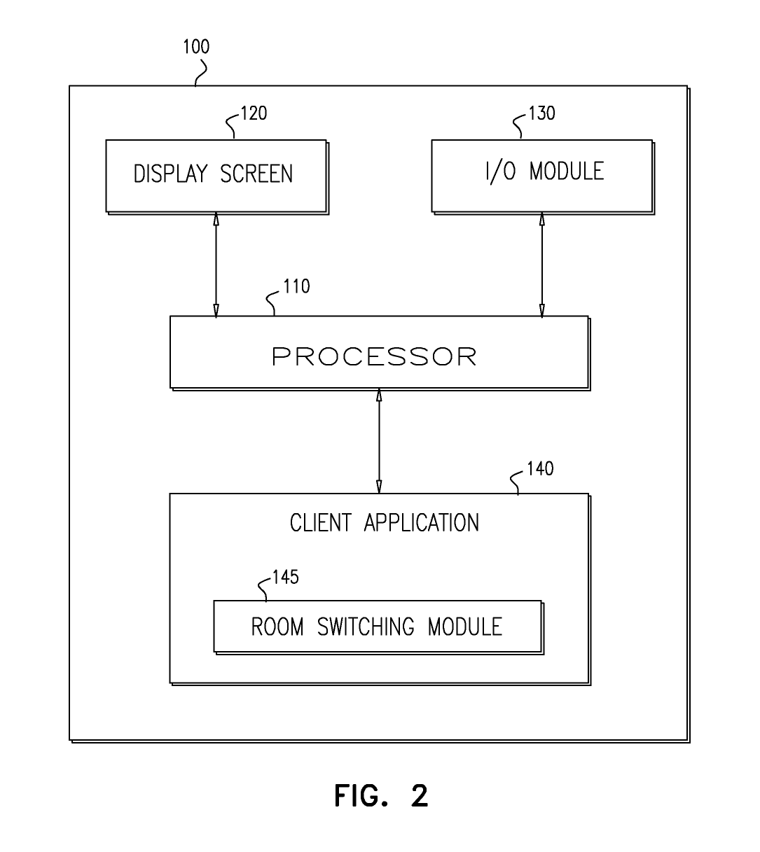

Reference is now made to FIG. 2 which is a schematic illustration of the exemplary client user device 100 of the embodiments of FIGS. 1A-C. In accordance with embodiments described herein, user device 100 may be implemented on any computing device suitable to present and process group conversation room 30 and private conversation room 40, such as, but not limited to, a smartphone, a computer tablet, a personal computer, etc.

It will be appreciated by one of skill in the art that user device 100 comprises hardware and software components that may provide at least the functionality of the embodiments of FIGS. 1A-1C. For example, user device 100 may comprise at least processor 110, display screen 120, I/O module 130, and client application 140. I/O module 130 may be implemented as a transceiver or similar means suitable for transmitting and receiving data (such as, for example, the collaborative communications depicted in FIGS. 1A-1C) between user device 100 and another device. Display screen 120 may be implemented as a touchscreen to facilitate the input of UI gestures such as shown in FIGS. 1A and 1B. It will be appreciated by one of skill in the art that user device 100 may also be configured with alternative means for receiving UI gestures. For example, user device 100 may also comprise a mouse, pointing device, and/or a keyboard to be used instead of, or in addition to, touchscreen functionality for the input of UI gestures.

It will be appreciated that user device 100 may comprise more than one processor 110. For example, one such processor 110 may be a special purpose processor operative to execute client application 140. It will be appreciated that client application 140 may be implemented in software and/or hardware. Client application 140 may be, for example, a collaboration application such as Cisco Spark™, Slack from Slack Technologies. Inc., and/or iOS Messages from Apple, Inc. It will be appreciated by one of ordinary skill in the art that client application 140 may be any suitable application that may provide functionality similar to the collaborative conversation rooms of the embodiments of FIGS. 1A-1C, such as, but not limited to, IM, text messaging and/or other collaboration applications.

Client application 140 comprises room switching module 145. Room switching module 145 may be implemented in software and/or hardware and may be invoked as necessary by client application 140 to detect and process the input of UI gestures for the changing of a conversational context such as the UI gestures depicted in FIGS. 1A and 1B.

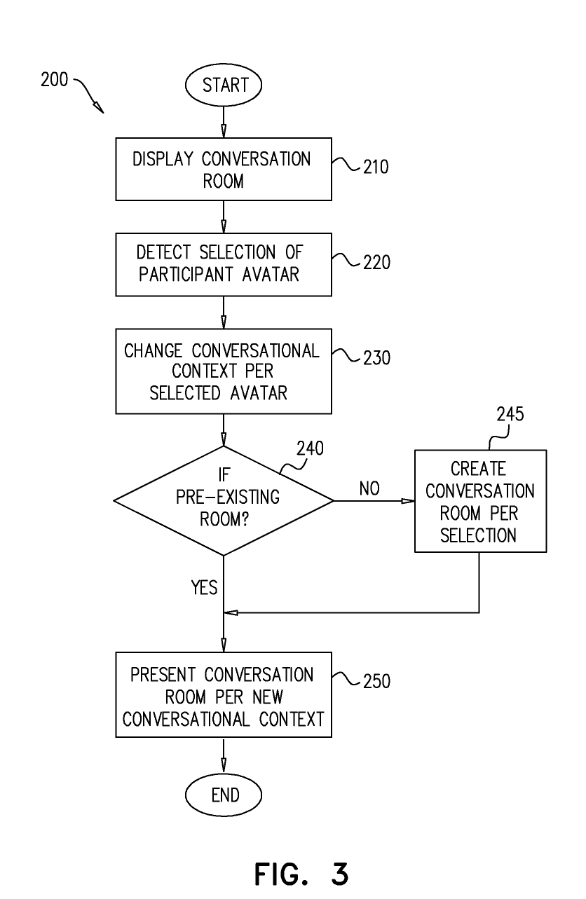

Reference is now made to FIG. 3 which illustrates a conversational contextual switching process 200, constructed and operative in accordance with embodiments described herein. Client application 140 may present (step 210) a group conversation such as, for example, group conversation room 30 as depicted in FIG. 1B. Client application 140 may then detect (step 220) the selection of a participant avatar such as, for example, participant avatar 35C in FIG. 2.

In response, client application 140 may invoke room switching module 145 to change (step 230) the conversational context per the selected participant avatar, e.g., participant avatar 35C as shown in FIG. 1B. In accordance with embodiments described herein, historical conversation data that is associated with previous instances of an individual conversation room may be included in the presentation of an individual conversation room, thus enabling the participants to continue a previously started conversation. Some or all of the historical conversation data may be stored locally in computer storage on user device 100 and retrieved as needed for presentation in a conversation room. Alternatively, and/or in addition, the historical conversation may be stored in part or in full on a remote server associated with client application 140.

It will be appreciated by one of skill in the art that the user of device 100 and the selected participant (i.e., “Jaime” per example) may not have a pre-existing individual conversation room. Accordingly, room switching module 145 may check if there is such a pre-existing room (step 240) and if not, it may prompt the user of device 100 to create (step 245) a conversation room per the selection.

Client application 140 may then present (step 250) the individual conversation room on display screen 120 of user device. It will be appreciated by those of skill in the art that in the case of a pre-existing room (per step 240) the presentation of the individual conversation room may include retrieval and presentation of the conversation thread from previous uses of the room, i.e., previously posted contribution by the participants, such as IM chat and shared content. It will also be appreciated that client application 140 may not support multiple concurrent conversational contexts; only one conversation room may be open on device 100 at any given time.

It will also be appreciated that client application 140 may support more than one mode of communication. While the exemplary embodiments of FIGS. 1A-1C may primarily depict IM chats, client application 140 may be configured to provide other modes of communication, such as, for example, voice and/or video communication. Process 200 may therefore be implemented for voice and/or video communication in addition to IM chat communication.

In accordance with embodiments described herein, room switching module 145 may be configured to autonomously switch the conversational context in accordance with a current mode of communication. User device 100 and client application 140 may be configured to support multiple modes of communication between participants of a conversation room. For example, user device 100 may be a communication device such as a smartphone that may provide voice functionality via I/O module 130. User device 100 may also be implemented as a personal computer or laptop computer that may be similarly configured to provide voice functionality via I/O module 130. Similarly, user device 100 may also be configured with a camera that may provide video functionality.

Accordingly, if a current mode of communication is IM chat, then process 200 may be used to open an individual conversation room for IM chat as described hereinabove. If a current mode of communication is an audio conference call, then process 200 may be used to switch the conversational context to a private, one-to-one voice call. If a current mode of communication is a video conference call, then process 200 may be used to switch the conversational context to a private, one-to-one video call. Regardless of the mode of communication, the steps of process 200 may be used to present the conversation (step 210), detect selection of a participant avatar (step 220), change the conversational context (step 230) per the selected avatar, determine whether or not to open a new conversation room (Steps 240, 245), and present the new conversation room.

In accordance with embodiments described herein, client application 140 may be configured to maintain a current communication mode when invoking room switching module 145, thereby streamlining the process and enabling the user of user device 100 to seamlessly switch to a private, one-to-one context with a minimum of steps.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method for switching conversational context in a collaborative environment, the method implemented on a computing device and comprising:
presenting a group conversation on a display screen associated with said computing device, wherein said presenting comprises display of at least collaborative communications and associated participant avatars;
detecting selection of one of said associated participant avatars in said group conversation;
switching from said group conversation to an individual conversation, said individual conversation conducted between individual conversation participants, wherein said individual conversation participants comprise a user of said computing device and one of said conversation participants according to said selected participant avatar; and
replacing said group conversation on said display screen with a presentation of said individual conversation.

2. The method according to claim 1 and also comprising:
defining said conversational context as said group conversation, wherein said group conversation is conducted between group conversation participants, said group conversation participants comprising at least said user of said computing device and at least two other participating users:
transmitting and receiving conversation data associated with collaborative communications exchanged between said group conversation participants; and
associating each of said collaborative communications with its respective contributor from among said group conversation participants according to a participant avatar associated with said contributor.

3. The method according to claim 1 and wherein said replacing comprises:
receiving historical conversation data previously exchanged in a previous instance of said individual conversation; and
presenting said historical conversation data on said display screen.

4. The method according to claim 1 and wherein said replacing comprises:
checking for a previous instance of said individual conversation; and
if said previous instance of said individual conversation is not found during said checking, prompting said user of said computing device to create said individual conversation.

5. The method according to claim 1 and wherein said detecting comprises detecting a tap on a touchscreen display of said one of said associated participant avatars.

6. The method according to claim 1 and wherein said detecting comprises detecting a mouse click on a display of said one of said associated participant avatars.

7. The method according to claim 1 and wherein said presenting is in accordance with a current mode of communication, wherein said mode of communication is one of IM chat, voice or video communications.

8. The method according to claim 7 and wherein said switching comprises autonomously maintaining said current mode of communication for said individual conversation.

9. A computing device comprising:
an I/O module operative to send and receive collaborative communications;
a display screen operative to display said collaborative communications in conversation rooms;
a processor; and
a client application to be executed by said processor, wherein said client application is operative to:
present a presentation of a group conversation on said display screen, wherein said presentation comprises display of at least said collaborative communications and associated participant avatars;
detect selection of one of said associated participant avatars;
switch said group conversation to an individual conversation, said individual conversation conducted between individual conversation participants, wherein said individual conversation participants comprise a user of said computing device and one of said conversation participants according to said selected participant avatar; and
replace said group conversation on said display screen with a presentation of said individual conversation.

10. The computing device according to claim 9 and wherein said client application is also operative to:
define said collaborative communications as having a conversational context of said group conversation, wherein said group conversation is conducted between group conversation participants, said group conversation participants comprising at least said user of said computing device and at least two other participating users;
employ said I/O module to transmit and/or receive conversation data associated with said collaborative communications exchanged between said group conversation participants; and
associate each of said collaborative communications with its respective contributor from among said group conversation participants according to a participant avatar associated with said contributor.

11. The computing device according to claim 9 and also comprising:
computer storage configured to store historical conversation data previously exchanged in a previous instance of said individual conversation, wherein said client application is also configured to retrieve said historical conversation data from said computer storage and to present said historical conversation data on said display screen.

12. The computing device according to claim 9 and wherein said client application is further configured to:
check for a previous instance of said individual conversation; and
if said previous instance of said individual conversation is not found during said check, to prompt said user of said computing device to create said individual conversation.

13. The computing device according to claim 9 and wherein said display screen is a touchscreen operative to detect a tap on a display of said one of said associated participant avatars.

14. The computing device according to claim 9 and wherein said client application is further configured to detect a mouse click on a display of said one of said associated participant avatars on said display screen.

15. The computing device according to claim 9 and wherein said client application is further configured to present said group conversation in accordance with a current mode of communication, wherein said mode of communication is one of IM chat, voice or video communications.

16. The computing device according to claim 15 and wherein said client application is further configured to autonomously maintain said current mode of communication for said individual conversation.

17. A computing device for switching conversational context in a collaborative environment, the method implemented on a computing device and comprising:
means for presenting a group conversation on a display screen associated with said computing device, wherein said presenting comprises display of at least collaborative communications and associated participant avatars;
means for detecting selection of one of said associated participant avatars in said group conversation;
means for switching from said group conversation to an individual conversation, said individual conversation conducted between individual conversation participants, wherein said individual conversation participants comprise a user of said computing device and one of said conversation participants according to said selected participant avatar; and
means for replacing said group conversation on said display screen with a presentation of said individual conversation.

18. The computing device according to claim 17 and also comprising:
means for defining said conversational context as said group conversation, wherein said group conversation is conducted between group conversation participants, said group conversation participants comprising at least said user of said computing device and at least two other participating users;
means for transmitting and receiving conversation data associated with collaborative communications exchanged between said group conversation participants; and
means for associating each of said collaborative communications with its respective contributor from among said group conversation participants according to a participant avatar associated with said contributor.

19. The computing device according to claim 15 and wherein said replacing comprises:
means for receiving historical conversation data previously exchanged in a previous instance of said individual conversation; and
means for presenting said historical conversation data on said display screen.

20. The method according to claim 15 and wherein said presenting is in accordance with a current mode of communication, wherein said mode of communication is one of IM chat, voice or video communications, and said switching comprises autonomously maintaining said current mode of communication for said individual conversation.
